(19) United States
(12) Patent Application Publication
(10) Pub. No.: US 2026/0099106 A1
(43) Pub. Date: Apr. 9, 2026

(54) TONER FOR DEVELOPMENT OF ELECTROSTATIC LATENT IMAGES

(71) Applicant: KYOCERA Document Solutions Inc., Osaka (JP)

(72) Inventor: Nanako MORISHITA, Osaka (JP)

(73) Assignee: KYOCERA Document Solutions Inc., Osaka (JP)

(21) Appl. No.: 19/347,568

(22) Filed: Oct. 1, 2025

(30) Foreign Application Priority Data
Oct. 8, 2024 (JP) 2024-176493

(51) Int. Cl. G03G 9/093; G03G 9/087

(52) U.S. Cl. CPC G03G 9/09321; G03G 9/08755; G03G 9/09335

(57) ABSTRACT

Toner for development of electrostatic latent images has a toner particle including a toner core particle and a shell layer that coats it. The toner core particle includes, at least, a binder resin and a colorant. The toner core particle contains as the binder resin a particular polyester resin having a repeating unit derived from 1,2-propanediol. The shell layer contains a alcoholic hydroxy group containing resin having one or more types of repeating unit having an alcoholic hydroxy group. The proportion of an alcoholic hydroxy group containing monomer in the alcoholic hydroxy group containing resin is 1 mass % or more. The coverage ratio of the surface of the toner core particle with the shell layer is 75% or more.

### INCORPORATION BY REFERENCE

This application is based on and claims the benefit of priority from Japanese Patent Application No. 2024-176493 filed on Oct. 8, 2024, the contents of which are hereby incorporated by reference.

### BACKGROUND

The present disclosure relates to toner for development of electrostatic latent images.

In general, in an electrophotographic method, the surface of an electrostatic latent image carrying member is electrostatically charged by corona discharge or the like and is then exposed to laser light or the like to form an electrostatic latent image. The formed electrostatic latent image is developed with toner to form a toner image. The formed toner image is transferred to a recording medium to produce a high-quality image. Typically, as toner for use in an electrophotographic method, a binder resin such as a thermoplastic resin is blended with a colorant, a charge control agent, a release agent, a magnetic material, and the like and the mixture is then subjected to kneading, pulverization, and classification to obtain toner particles (toner base particles) with an average particle size of 5 μm or more but 10 μm or less. Then, for the purposes of giving the toner fluidity, giving it satisfactory charging properties, and improving the cleaning properties of the toner against a photosensitive drum, an inorganic fine powder such as silica or titanium oxide is externally added to the toner base particles.

One known type of toner used as such toner has a core-shell structure in which a toner core particle employing a low-melting-point binder resin is coated with a shell layer of a resin with a glass transition point (Tg) higher than the glass transition point of the binder resin of the toner core particle for the purposes of obtaining satisfactory fixing properties in a low temperature range, improving preservation stability at high temperature, improving blocking resistance, and the like.

### SUMMARY

According to one aspect of the present disclosure, toner for development of electrostatic latent images has a toner particle that includes a toner core particle and a shell layer that coats it. The toner core particle includes, at least, a binder resin and a colorant. The toner core particle contains as the binder resin a particular polyester resin having a repeating unit derived from 1,2-propanediol. The shell layer contains an alcoholic hydroxy group containing resin having one or more types of repeating unit having an alcoholic hydroxy group. The proportion of an alcoholic hydroxy group containing monomer in the alcoholic hydroxy group containing resin is 1 mass % or more. The coverage ratio of the surface of the toner core particle with the shell layer is 75% or more.

### DETAILED DESCRIPTION

An embodiment of the present disclosure will be described in detail below. Unless otherwise defined, a result of evaluation (i.e., a value related to a shape, property, or the like) with respect to a powdery substance (specifically, toner core particle, toner base particle, external additive, toner, and the like) is given as a number average of values obtained respectively for an appropriate number of average particles selected from the powdery substance. Unless otherwise defined, a number average particle size of a powdery substance is a number average value of the circle-equivalent diameter (the diameter of a circle with the same area as the projection area of a particle) of primary particles measured under a microscope. Unless otherwise defined, a measured value of the volume median diameter (D50) of a powdery substance is a value measured using a laser diffraction/scattering particle size distribution analyzer (“LA-750” produced by Horiba Ltd.). Unless otherwise defined, a measured value of an acid number or a hydroxy group number is a value measured in conformity with JIS (Japanese Industrial Standards) K0070-1992. Unless otherwise defined, a measured value of a number average molecular weight (Mn) or a mass average molecular weight (Mw) is a value measured by gel permeation chromatography.

In the following description, “-based” is occasionally appended to the name of a compound to collectively refer to that substance and their derivatives. Wherever the name of a compound has “-based” appended to it in the name of a polymer, the repeating unit in the polymer is derived from any of that compound and their derivatives. The term “(meth)acrylic” is occasionally used to refer to “acrylic” and “methacrylic” collectively. The term “(meth)acryloyl is occasionally used to refer to “acryloyl” (CH₂=CH—CO—) and “methacryloyl” (CH₂═C(CH₃)—CO—) collectively.

Toner according to the embodiment can be used, for example, as positively chargeable toner suitably for development of electrostatic latent images. The toner according to the embodiment is a powdery substance containing a plurality of toner particles (each configured as described later). The toner can be used as one-component developer. The toner can be mixed with carrier using a mixing apparatus (e.g., a ball mill) to prepare two-component developer. To form high-quality images, it is preferable to use ferrite carrier as the carrier. To form high-quality images over a long period, it is preferable to use magnetic carrier particles that have a carrier core and a resin layer coating the carrier core. To produce magnetic carrier particles, the carrier core can be formed with a magnetic material (e.g., ferrite) or the carrier core can be formed with resin having magnetic particles dispersed in it. Or, magnetic particles can be dispersed in the resin layer coating the carrier core. To form high-quality images, the amount of toner in two-component developer is preferably 5 mass parts or more but 15 mass parts or less for mass parts of carrier. Positively chargeable toner is charged positive by friction with carrier.

The toner according to the embodiment can be used, for example, to form images on an electrophotographic apparatus (image forming apparatus). One example of an image formation method on an electrophotographic apparatus will be described below.

First, based on image data, an electrostatic latent image is formed on a photosensitive member (e.g., in a superficial part of a photosensitive drum). Next, the formed electrostatic latent image is developed with developer containing toner. In the development process, toner (e.g., toner electrostatically charged by friction with carrier or a blade) on a development sleeve (e.g., a superficial part of a development roller in a developing device) disposed near the photosensitive member is attached to the electrostatic latent image to form a toner image on the photosensitive member. In the subsequent transfer process, the toner image on the photosensitive member is transferred directly to a recording medium (e.g., paper); or it is first primarily transferred to an intermediate transfer member (e.g., transfer belt) and then the toner image on the intermediate transfer member is secondarily transferred to a recording medium. After that, the toner is heated so that the toner is fixed to the recording medium. In this way, an image is formed on the recording medium. By superposing on each other toner images of four colors, for example, black, yellow, magenta, and cyan, it is possible to form a full-color image.

### [1. Basic Configuration of Toner]

Toner according to the present disclosure for development of electrostatic latent images (in the following description, often referred to simply as the toner) has a toner core particle and a shell layer (capsule layer) formed on the surface of the toner core particle. The shell layer is formed substantially of resin. For example, by coating a toner core particle that melts at low temperature with a shell layer that has high resistance to heat, it is possible to give the toner satisfactory heat-resistant preservation properties and low-temperature fixing properties. An additive can be dispersed in the resin forming the shell layer.

The shell layer can cover the entire surface of the toner core particle, or can partly cover the surface of the toner core particle. An external additive can be attached to the surface of the shell layer (or a surface region of the toner core particle that is not covered by the shell layer). Unless necessary, the external additive can be omitted. Toner that chiefly contains toner particles with a shell layer can contain toner particles with no shell layer. In the following description, a toner particle before an external additive is attached to it is referred to as a toner base particle. A material for forming a toner core particle is referred to as a toner core material. A material for forming a shell layer is referred to a shell material.

### (Toner Core Particle)

The toner core particle at least contains a binder resin and a colorant. The toner core particle contains as the binder resin a polyester resin having a repeating unit derived from 1,2-propanediol (hereinafter such a polyester resin will be referred to as a particular polyester resin). 1,2-propanediol has a very low molecular weight as compared with alcohol components (e.g., bisphenol A and the like) used as a source material for common polyester resins for toner. Accordingly, as compared with common polyester resins for toner with similar molecular weights, a particular polyester resin exhibits a high degree of polymerization. Moreover, 1,2-propanediol has no rigid structure like the benzene ring structure as compared with bisphenol A and the like mentioned above. Accordingly, as compared with common polyester resins for toner, a particular polyester resin has a flexible skeleton and tends to reduce the heat-resistant preservation properties and the anti-hot offsetting properties of toner.

### (Shell Layer)

The shell layer is formed substantially of a resin having one or more types of repeating unit having an alcoholic hydroxy group (hereinafter such a resin will be referred to as an alcoholic hydroxy group containing resin). More specifically, it is preferable that, of the resin that forms the shell layer, 90 mass % or more but 100 mass % or less be an alcoholic hydroxy group containing resin. The proportion of any repeating units having an alcoholic hydroxy group in all repeating units in the alcoholic hydroxy group containing resin is 0.1 mass % or more but 20 mass % or less. The alcoholic hydroxy group containing resin can contain two or more types of repeating unit having an alcoholic hydroxy group.

While the thickness of the shell layer is not particularly limited within the scope consistent with the object of the present disclosure, if the shell layer has too large a thickness, when the toner is fixed to the recording medium, the pressure applied to the toner may fail to break the shell layer. In that case, the binder resin and the release agent contained in the toner core particle do not soften or melt quickly, leading to difficulty in fixing the toner to the recording medium in a low-temperature range. On the other hand, if the shell layer has too small a thickness, it has low mechanical strength. With low mechanical strength, the shell layer may break under impact during transport. Thus, if the toner is stored at high temperature, for example, the release agent may seep out through a broken part of the shell layer onto the surface of the toner, making the toner easy to agglomerate.

The thickness of the shell layer is preferably, 0.03 μm or more but 1 μm or less, more preferably 0.04 μm or more but 0.7 μm or less, particularly preferably 0.05 μm or more but 0.5 μm or less, and most preferably 0.05 μm or more but 0.3 μm or less.

The thickness of the shell layer can be measured by inspecting a section of the toner on a transmission electron microscope (TEM) and analyzing a TEM scan image with commercially available image analysis software. One example of usable commercially available image analysis software is WinROOF (produced by Mitani Corporation).

The toner according to the present disclosure has a basic configuration as described above, that is, it is a capsule toner having a toner core particle containing a particular polyester resin and a shell layer containing an alcoholic hydroxy group containing resin. This results in high affinity between the toner core particle and the shell layer, making the shell layer uniform. Thus, the toner according to the present disclosure has satisfactory low-temperature fixing properties and heat-resistant preservation properties. Moreover, regardless of the environment in which it is used, the toner according to the present disclosure has sufficient charging stability and can form high-quality images (e.g., images with low fogging density) in a normal-temperature normal-humidity environment as well as in a high-temperature high-humidity environment.

The factor contributing to the high affinity between the toner core particle and the shell layer is the closeness between the SP values (solubility parameters) of the 1,2-propanediol in the toner core particle and the monomer containing an alcoholic hydroxy group in the shell layer. Moreover, with a particular polyester resin, the hydroxy group in 1,2-propanediol results in a larger number of hydroxy groups than in common polyester resins, and this gives the toner core particle satisfactory dispersibility in water.

Thus, combining the toner core particle containing a particular polyester resin with the shell layer containing an alcoholic hydroxy group containing resin results in the functional group derived from the 1,2-propanediol in the toner core particle chemically reacting with and binding to the alcoholic hydroxy group in the shell layer. This permits the shell layer to bond uniformly to the surface of the toner core particle, forming a shell layer that coats the toner core particle with a high coverage ratio.

In the toner according to the present disclosure, the toner core particle need not have its entire surface coated by the shell layer. It should however be noted that, the lower the coverage ratio of the toner core particle with the shell layer (the ratio of the area coated by the shell layer to the surface area of the toner core particle), the poorer the heat-resistant preservation properties of the toner. To give the toner satisfactory heat-resistant preservation properties and low-temperature fixing properties, the shell layer needs to cover 75% or more of the area of the surface region of the toner core particle (i.e., the coverage ratio needs to be 75% or more). The condition of the coating of the surface of the toner core particle with the shell layer can be checked on a scanning electronic microscope (SEM).

### [2. Materials of Toner]

Next, a description will be given of the essential or optional components of the toner according to the present disclosure. The toner core particle contains, in the binder resin, at least a colorant. It can further contain, as necessary, a release agent, a charge control agent, a magnetic powder, and the like. The shell layer contains an alcoholic hydroxy group containing resin. The toner according to the present disclosure can, if so desired, have its surface treated with an external additive.

Now, a description will be given, one by one, of the binder resin, the colorant, the release agent, the charge control agent, and the magnetic powder that form the toner core particle, the alcoholic hydroxy group containing resin that forms the shell layer, and the external additive as well as a production method for the toner according to the present disclosure.

### (Binder Resin)

The toner core particle of the toner according to the present disclosure contains as a binder resin a particular polyester resin. Preferably, the particular polyester resin is amorphous. As compared with a crystalline particular polyester resin, an amorphous particular polyester resin is less prone to affect the chargeability of toner particles. Accordingly, the toner core containing the amorphous particular polyester resin helps further enhance the charging stability of the toner according to the present disclosure. Now, the particular polyester resin will be described.

The particular polyester resin has a repeating unit derived from 1,2-propanediol. That is, for the particular polyester resin, 1,2-propanediol is used as a source material. The particular polyester resin is obtained, for example, by condensation-polymerizing 1,2-propanediol with one or more types of polyvalent carboxylic acid. Examples of carboxylic acids for synthesizing a particular polyester resin includes divalent carboxylic acids and trivalent or higher carboxylic acids as mentioned below. Instead of polyvalent carboxylic acids, it is also possible to use derivatives of polyvalent carboxylic acids that can form ester bonds by condensation polymerization (e.g., anhydrides of polyvalent carboxylic acids and halides of polyvalent carboxylic acids).

Chemical products that make great use of plant-derived industrial resources (biomass) are preferred from the carbon-neutral perspective because they can be combusted with a suppressed increase in the concentration of carbon dioxide in the atmosphere. Accordingly, chemical products that make great use of biomass are effective in reducing the burden on the environment. It is therefore preferable to use plant-derived 1,2-propanediol as a source material for the particular polyester resin.

As an index of the biomass content, it is common to use the concentration of the radioactive carbon isotope ¹⁴C (the proportion of the radioactive carbon isotope ¹⁴C in all carbon elements; in the following description also referred to simply as the “¹⁴C concentration”). Biomass is consumed in a comparatively short period after a plant ceases vital activity. Accordingly, the ¹⁴C concentration in biomass is 107.5 pMC (percent modern carbon), which is largely equal to the ¹⁴C concentration in the atmosphere. By contrast, fossil resources such as petroleum are consumed several tens of thousands to several hundred million years after the animals and plants of origin ceased vital activity. Accordingly, almost no ¹⁴C is detected in fossil resources. Thus, the ¹⁴C concentration in chemical products that make sole use of fossil resources such as petroleum as a source material is nearly 0 pMC. By contrast, chemical products that make use of biomass as a source material have increasingly high ¹⁴C concentrations in proportion to the amount of biomass they use. Let X [pMC] be the concentration of the radioactive carbon isotope ¹⁴C in toner, then the proportion of biomass-derived carbon in the carbon in toner can be found according to the expression below:

$$Proportion [ \% ] of Biomass - Derived Carbon = ( X / 10 \; 7.5 ) \times 100$$

In the toner according to the present disclosure, the ¹⁴C concentration in toner particles is preferably 26.9 pMC or more, and more preferably 53.8 pMC or more. If the ¹⁴C concentration in toner particles is 26.9 pMC or more, the content percentage of biomass-derived (biomass-based) carbon is approximately 25.0 mass % or more. Such toner in which the content percentage of biomass-derived carbon is 25.0 mass % or more is a product that makes comparatively great use of biomass as a source material and puts little burden on the environment; it is thus eligible, for example, for a Biomass Plastic Mark (an authentication by Japan BioPlastics Association).

The source material for the particular polyester resin can contain, in addition to 1,2-propanediol and a polyvalent carboxylic acid, any polyhydric alcohol compound other than 1,2-propanediol. Examples of other polyhydric alcohols include dihydric alcohol compounds (more specifically, diol compounds, bisphenol compounds, and the like) and trihydric and higher alcohol compounds. For an increased ¹⁴C concentration in toner particles, however, it is preferable that the source material for the particular polyester resin not contain any other polyhydric alcohol compound. Specifically, in the source material for the particular polyester resin, the content proportion of any other polyhydric alcohol compound is preferably 10 mass % or less, and more preferably 0 mass %.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane thicarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and empole trimer acid. These divalent or trivalent or higher carboxylic acid components can be used as ester-forming derivatives such as acid halides, acid anhydrides, and lower alkyl esters. Here, the term “lower alkyl” denotes an alkyl group with one to six carbon atoms.

Preferred as the particular polyester resin is a condensation polymer of 1,2-propanediol, terephthalic acid, and trimellitic anhydride. The content proportion of the particular polyester resin in the toner core particle is preferably 60 mass % or more but 95 mass % or less, and more preferably 75 mass % or more but 85 mass % or less.

While the toner core particle preferably contains only a particular polyester resin as a binder resin, it can further contain any other binder resin other the particular polyester resin. In the binder resin contained in the toner core particle, the content proportion of the other binder resin is preferably 5 mass % or less, and more preferably 0 mass %. Examples of other binder resins include polyester resin other than the particular polyester resin, styrene-based resin, acrylic acid ester-based resin, olefin-based resin (more specifically, polyethylene resin, polypropylene resin, and the like), vinyl resin (more specifically, vinyl chloride resin, polyvinyl alcohol, vinyl ether resin, N-vinyl resin, and the like), polyamide resin, and urethane resin. Also usable as other binder resins are copolymers of the resins enumerated above, that is, copolymers that have any repeating unit introduced in any of the resins enumerated above (more specifically, styrene-acrylic acid ester-based resin, styrene-butadiene-based resin, and the like).

The acid number of the particular polyester resin is 14 mgKOH/g or more but 32 mgKOH/g or less, and preferably 18 mgKOH/g or more but 25 mgKOH/g or less. Setting the acid number of the particular polyester resin to 14 mgKOH/g or more allows sufficient cross-linking of a shell layer forming resin, which will be described later, with the particular polyester resin contained in the toner core. This helps enhance the heat-resistant preservation properties and the anti-hot offsetting properties of the toner according to the present disclosure. Setting the acid number of the particular polyester resin to 32 mgKOH/g or less helps suppress excessive cross-linking of a shell layer forming resin, which will be described later, with the particular polyester resin contained in the toner core. This helps enhance the low-temperature fixing properties of the toner according to the present disclosure.

The acid number of the particular polyester resin can be measured by a method conforming to JIS (Japanese Industry Standards) K0070-1992. The acid number of the particular polyester resin can be adjusted, for example, by changing the type or amount of carboxylic acid used to synthesize the particular polyester resin. Specifically, using a carboxylic acid that contains a large number of carboxylic groups in one molecule (e.g., a trivalent or higher carboxylic acid) results in increasing the acid number of the synthesized particular polyester resin. Likewise, increasing the added amount of carboxylic acid relative to the added amount of alcohol compound results in increasing the acid number of the particular polyester resin.

The softening point (Tm) of the particular polyester resin is preferably 108° C. or more but 132° C. or less, and more preferably 115° C. or more but 125° C. or less. Setting the softening point (Tm) of the particular polyester resin to 108° C. or more helps further enhance the anti-hot offsetting properties of the toner according to the present disclosure. Setting the softening point (Tm) of the particular polyester resin to 132° C. or less helps further enhance the low-temperature fixing properties of the toner according to the present disclosure.

The glass transition point (Tg) of the particular polyester resin is preferably 40° C. or more but 65° C. or less, and more preferably 50° C. or more but 60° C. or less. Setting the glass transition point of the particular polyester resin to 40° C. or more helps further enhance the heat-resistant preservation properties of the toner according to the present disclosure. Setting the glass transition point (Tg) of the particular polyester resin to 65° C. or less helps further enhance the low-temperature fixing properties of the toner according to the present disclosure.

### (Colorant)

The toner core particle contains a colorant. As the colorant that can be contained in the toner core particle, any known pigment or dye that suits the color of the toner can be used. Specific examples of suitable colorants that can be added to the toner include black pigments such as carbon black, acetylene black, lamp black, and aniline black; yellow pigments such as chrome yellow, zinc yellow, cadmium yellow, yellow iron oxide, mineral fast yellow, nickel titanium yellow, Naples yellow, naphthol yellow S, Hansa yellow G, Hansa yellow 10G, benzidine yellow G, benzidine yellow GR, quinoline yellow lake, permanent yellow NCG, tartrazine lake, monoazo yellow, and diazo yellow; orange pigments such as reddish chrome yellow, molybdenum orange, permanent orange GTR, pyrazolone orange, Vulcan Orange, and indanthrene brilliant orange GK; red pigments such as red iron oxide, cadmium red, red lead, mercury cadmium sulfide, permanent Red 4R, lithol red, pyrazolone red, Watchung red calcium salt, lake red D, brilliant carmine 6B, cosine lake, rhodamine lake B, alizarin lake, brilliant carmine 3B, and monoazo red; violet pigments such as manganese violet, fast violet B, and methyl violet lake; blue pigments such as Prussian blue, cobalt blue, alkali blue lake, partially chlorinated Victoria blue, fast sky blue, indanthrene blue BC, and phthalocyanine blue; green pigments such as chrome green, chromium oxide, pigment green B, malachite green lake, and final yellow green G; white pigments such as zinc white, titanium oxide, antimony white, and zinc sulfide; and extender pigments such as barite powder, barium carbonate, clay, silica, white carbon, talc, and alumina white. Two or more of these pigments can be used in combination for the purpose, among others, of adjusting the toner to the desired hue.

The amount of colorant used is not particularly limited within the scope consistent with the object of the present disclosure. Specifically, the amount of colorant used is, for the total mass of the toner core particle, preferably 1 mass % or more but 10 mass % or less, and more preferably 2 mass % or more but 7 mass % or less.

A colorant can be used as a master batch having the colorant previously dispersed in a resin material such as a thermoplastic resin. When a colorant is used as a master batch, the resin contained in the master batch is preferably a resin of the same type as the binder resin.

### (Release Agent)

For the purpose of improving its fixing properties and anti-offsetting properties, the toner core particle can contain a release agent. The type of release agent that can be contained in the toner core particle is not limited within the scope consistent with the object of the present disclosure. As the release agent, wax is preferred. Examples of wax include carnauba wax, synthetic ester wax, polyethylene wax, polypropylene wax, fluorocarbon-based wax, Fischer-Tropsch wax, paraffin wax, montan wax, and rice wax. Two or more of these release agents can be used in combination. Adding these release agents to the toner core particle helps more effectively suppress offsetting and image smearing (stain around an image caused by its being rubbed).

From the viewpoint of compatibility with the particular polyester resin used as the binder resin, suitably used as the release agent is one or more release agents selected from the group consisting of carnauba wax, synthetic ester wax, and polyethylene wax.

The amount of release agent used is not particularly limited within the scope consistent with the object of the present disclosure. Specifically, the amount of release agent used is preferably 1 mass % or more but 10 mass % or less of the total mass of the toner core particle. Using too small an amount of release agent can result in insufficient suppression of offsetting and image smearing in image formation; using too large an amount of release agent can result in fusing-together of toner particles and hence poor heat-resistant preservation properties of the toner.

### (Charge Control Agent)

The toner core particle can contain a charge control agent for the purpose of improving the charge level of the toner and its charge response properties as an index of whether it can be charged to a predetermined charge level in a short time and thereby obtaining toner with excellent durability and stability. In development with toner positively charged, a positively chargeable charge control agent is used; in development with toner negatively charged, a negatively chargeable charge control agent is used.

The type of charge control agent that can be contained in the toner core particle is not particularly limited within the scope consistent with the object of the present disclosure. Any of charge control agents known to be used in toner can be appropriately selected and used. Specific examples of positively chargeable charge control agents include azine compounds such as pyridazine, pyrimidine, pyrazine, orthoxazine, metaoxazine, paraoxiazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes comprising azine compounds, such as azine fast red FC, azine fast red 12BK, azine violet BO, azine brown 3G, azine light brown GR, azine dark green BH/C, azine deep black EW, and azine deep black 3RL; nigrosine compounds such as nigrosine, nigrosine salts, and nigrosine derivatives; acid dyes comprising nigrosine compounds, such as nigrosine BK, nigrosine NB, and nigrosine Z; metal salts of naphthenic acid or higher fatty acids; alkoxylated amines; alkylamides; and quaternary ammonium salts such as benzylmethylhexyldecylammonium and decyltrimethylammonium chloride. Among these positively chargeable charge control agents, nigrosine compounds are particularly preferred for their faster charge response properties. Two or more of these positively chargeable charge control agents can be used in combination.

Also usable as a positively chargeable charge control agent are resins that have as a functional group a quaternary ammonium salt, a carboxylic acid salt, or a carboxyl group. Specific examples include styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins are not particularly limited within the scope consistent with the object of the present disclosure, and they can be in the form of an oligomer or a polymer.

Among resins usable as a positively chargeable charge control agent, from the viewpoint of easy adjustment of the amount of charge within a desired range, styrene-acrylic-based resin having as a functional group a quaternary ammonium salt is more preferred. In styrene-acrylic-based resins having as a functional group a quaternary ammonium salt, specific examples of preferred acrylic-based comonomers for copolymerization with the styrene unit include esters of alkyl (meth)acrylates such as methyl acrylate, ethyl acrylate, n-propyl acrylate, isopropyl acrylate, n-butyl acrylate, isobutyl acrylate, 2-ethylhexyl acrylate, methyl methacrylate, ethyl methacrylate, n-butyl methacrylate, and isobutyl methacrylate.

Used as a quaternary ammonium salt is a unit derived by a quarternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethyl aminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acryl amide include dimethyl methacryl amide. Specific examples of dialkyl aminoalkyl (meth)acryl amide include dimethyl aminopropyl methacryl amide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamid can be used together.

Specific examples of negatively chargeable charge control agents include organic metal complexes, chelate compounds, monoazo metal complexes, acetylacetone metal complexes, aromatic hydroxycarboxylic acids, aromatic dicarboxylic acid-based metal complexes, aromatic monocarboxylic acids, and aromatic polycarboxylic acids along with their metal salts, anhydrides, and esters, as well as phenol derivatives such as bisphenol. Among these, organic metal complexes and chelate compounds are preferred. More preferred as organic metal complexes and chelate compounds are acetylacetone metal complexes such as aluminum acetylacetonate and iron (II) acetylacetonate, and salicylic acid-based metal complexes and salicylic acid-based metal salts such as chromium 3,5-di-tert-butyl salicylate, particularly preferred being salicylic acid-based metal complexes and salicylic acid-based metal salts. Two or more of these negatively chargeable charge control agents can be used in combination.

The amount of positively or negatively chargeable charge control agent used is not particularly limited within the scope consistent with the object of the present disclosure. Typically, the amount of positively or negatively chargeable charge control agent used is preferably 0.1 mass % or more but 10 mass % or less of the total mass of the toner core particle. Using too small an amount of charge control agent makes it difficult to stably charge the toner with a predetermined polarity. This can lead to a lower-than-expected image density in the formed image and make it difficult to maintain satisfactory image density for a long period. Also the charge control agent is then difficult to disperse evenly, and this tends to cause fogging in the formed image and contamination of a latent image carrying member with toner components. Using too large an amount of charge control agent leads to poorer resistance to environment, resulting in image defects in the formed image due to insufficient charging under high temperature and high humidity and contamination of a latent image carrying member with toner components.

### (Magnetic Powder)

The toner core particle can contain a magnetic powder. Suitably usable as the material of the magnetic powder is, for example, a ferromagnetic metal (more specifically, iron, cobalt, nickel, an alloy containing one or more of these metals, or the like), a ferromagnetic metal oxide (more specifically, ferrite, magnetite, chromium dioxide, or the like), or a material subjected to ferromagnetization (more specifically, a carbon material made ferromagnetic by heat treatment, or the like). To suppress the elution of a metal ion (e.g., iron ion) from the magnetic powder, preferably, it is preferable to use surface-treated magnetic particles as the magnetic powder. One type of magnetic powder can be used singly or a plurality of types of magnetic powder can be used in combination.

### (Alcoholic Hydroxy Group Containing Resin)

The shell layer of the toner according to the present disclosure is formed substantially of the alcoholic hydroxy group containing resin described above. Preferably, contained as a repeating unit having an alcoholic hydroxy group derived from an alcoholic hydroxy group containing monomer contained in the alcoholic hydroxy group containing resin is, for example, a repeating unit represented by Chemical Formula (1) below.

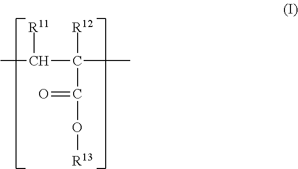

In Formula (1), R¹¹ and R¹² each independently represent a hydrogen atom, a halogen atom, or an alkyl group that can have a substituent; R¹³ represents an alkylene group that has a hydroxy group.

As each of R¹¹ and R¹² independently, a hydrogen atom or a methyl group is preferred, particularly preferred being a combination of a hydrogen atom as R¹¹ and a hydrogen atom or a methyl group as R¹². As R¹³, an alkylene group having a hydroxy group with a carbon number of one or more but six or less is preferred, particularly preferred being an alkylene group having a hydroxy group with a carbon number of one or more but four or less. Note that, in a repeating unit derived from 2-hydroxyethyl methacrylate, R¹¹ represents a hydrogen atom, R¹² represents a methyl group, and R₁₃ represents (—(CH₂)₂—OH).

For enhanced heat-resistant preservation properties, low-temperature fixing properties, and charging stability of the toner, it is preferable that the alcoholic hydroxy group containing resin that forms the shell layer contain, in addition to a repeating unit having an alcoholic hydroxy group derived from an alcoholic hydroxy group containing monomer, one or more types of repeating unit derived from a styrene-based monomer. Preferably, the repeating unit derived from a styrene-based monomer contains, for example, a repeating unit represented by Chemical Formula (2) below.

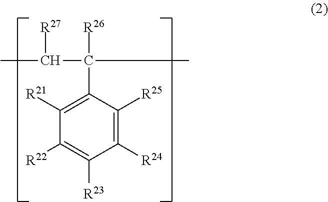

In Formula (2), R²¹ to R²⁷ each independently represent a hydrogen atom, a halogen atom, a hydroxygroup, an alkyl group that can have a substituent, an alkoxy group that can have a substituent, an alkoxyalkyl group that can have a substituent, or an aryl group that can have a substituent.

Preferred as each of R²¹ to R²⁷ independently is a hydrogen atom, a halogen atom, an alkyl group with a carbon number of one or more but four or less, an alkoxy group with a carbon number of one or more but four or less, or an alkoxyalkyl group with a carbon number of two or more but six or less (specifically, the total carbon number in alkoxy and alkyl). As each of R²⁶ and R²⁷ independently, a hydrogen atom or a methyl group is preferred, particularly preferred being a combination of a hydrogen atom as R²⁷ and a hydrogen atom or a methyl group as R²⁶. In a repeating unit derived from styrene, R²¹ to R²⁷ each represent a hydrogen atom.

The proportion of the alcoholic hydroxy group containing monomer in the alcoholic hydroxy group containing resin can be measured by a GC/M method. For example, in a case where the alcoholic hydroxy group containing resin is a copolymer of a styrene-based monomer, an acrylic acid-based monomer, and an alcoholic hydroxy group containing monomer, the value (Ma/Mb) calculated by dividing the mass Ma of one or more types of repeating unit derived from a alcoholic hydroxy group by the mass Mb of one or more repeating unit derived from a styrene-based monomer and one or more repeating unit derived from an acrylic acid-based monomer corresponds to the proportion of the repeating unit having the alcoholic hydroxy group in the alcoholic hydroxy group containing resin.

A low proportion of the alcoholic hydroxy group containing monomer in the alcoholic hydroxy group containing resin results in low affinity of the shell layer with the toner core particle. This makes it difficult to bond the shell layer uniformly to the surface of the toner core particle and leads to poor heat-resistant preservation properties. Setting the portion of the alcoholic hydroxy group containing monomer in the alcoholic hydroxy group containing resin to 1 mass % or more results in high affinity between the toner core particle and the shell layer, yielding toner with a high coverage ratio with the shell layer and excellent heat-resistant preservation properties.

The method for polymerizing the monomer mentioned above is not particularly limited within the scope consistent with the object of the present disclosure; any of methods such as solution polymerization, bulk polymerization, emulsion polymerization, and suspension polymerization can be selected.

In a case where a monomer with an unsaturated bond is addition-polymerized using an aqueous solvent as by emulsion polymerization or suspension polymerization, a surfactant can be used. The surfactant used is not particularly limited within the scope consistent with the object of the present disclosure and can be appropriately selected from the group consisting of anionic surfactants, cationic surfactants, and nonionic surfactants. Examples of anionic surfactants include sulfate ester salt-type surfactants, sulfonic acid salt-type surfactants, phosphate ester salt-type surfactants, and soap. Examples of cationic surfactants include amine salt-type surfactants and quaternary ammonium salt-type surfactants. Examples of nonionic surfactants include polyethylene glycol-type surfactants, alkyl phenol ethylene oxide adduct-type surfactants, and polyhydric alcohol-type surfactants that are derivatives of polyhydric alcohols such as glycerol, sorbitol, and sorbitan. Among these surfactants, it is preferable to use at least one of an anionic surfactant and a nonionic surfactant. Among those surfactants, one type can be used or two or more types can be used in combination.

The shell layer can contain, in addition to the alcoholic hydroxy group containing resin, any other thermoplastic resin. Examples of other thermoplastic resins include thermoplastic resins such as styrene-based resin, acrylic acid-based resin, styrene-acrylic acid-based resin, polyethylene-based resin, polypropylene-based resin, vinyl chloride-based resin, polyester resin, polyamide resin, polyurethane resin, polyvinyl alcohol-based resin, vinyl ether-based resin, N-vinyl-based resin, and styrene-butadiene resin.

### (External Additive)

The toner according to the present disclosure can, if so desired, be treated with an external additive after the shell layer has been formed on the surface of the toner core particle. In the following description, a particle to be treated with the external additive is occasionally referred to as “toner base particle.”

The type of external additive used is not particularly limited within the scope consistent with the object of the present disclosure and can be selected appropriately from external additives that are known to be used in toner. Specific examples of suitable external additives include silica; metal oxides such as alumina, titanium oxide, magnesium oxide, zinc oxide, strontium titanate, and barium titanate; and resin particles. Two or more of these external additives can be used in combination.

The particle size of the external additive is not particularly limited within the scope consistent with the object of the present disclosure; typically it is preferably 0.01 μm or more but 1.0 μm or less.

The amount of external additive used is not particularly limited within the scope consistent with the object of the present disclosure. Typically, the amount of external additive used is, for the total mass of the toner base particle produced by forming the shell layer on the surface of the toner core particle, preferably 0.1 mass % or more but 10 mass % or less, and more preferably 0.2 mass % or more but 5 mass % or less. Using too small an amount of external additive tends to lead to low hydrophobicity of the toner. This makes the toner susceptible to water molecules in air in a high-temperature high-humidity environment and tends to result in low image density of the formed image due to extremely reduced charge amount of the toner as well as poor flowability of the toner and other problems. On the other hand, using too large an amount of external additive can result in low image density due to excessive charging of the toner.

### [Production Method for Toner]

Next, a production method for the toner according to the present disclosure will be described. The production method for the toner is not particularly limited so long as it can form the toner core particle and the shell layer such that each has a predetermined structure. As necessary, external addition treatment can be performed by using as a toner base particle the toner core particle coated with the shell layer to attach an external additive to the surface of the toner base particle. As a suitable production method for the toner described above for development of electrostatic latent images, the following description discusses one by one a method for producing the toner core particle, a method for forming the shell layer, and a method for external addition treatment.

### (Method for Producing the Toner Core Particle)

The method for producing the toner core particle is not particularly limited so long as it can satisfactorily disperse any components such as a colorant, a release agent, a charge control agent, and a magnetic powder in a binder resin. According to one specific example of a suitable method for producing the toner core particle, first, a binder resin is mixed with other components such as a colorant, a release agent, a charge control agent, and a magnetic powder using a mixer or the like; then the binder resin and the components blended with it are melted and kneaded using a uniaxial or biaxial kneader or the like; and then the cooled kneaded product is pulverized and classified. The average particle size of the toner core particle is not particularly limited within the scope consistent with the object of the present disclosure; in general, it is preferably 5 μm or more but 10 μm or less.

### (Method for Forming the Shell Layer)

The shell layer is formed by attaching resin fine particles to the surface of the toner core particle so as to coat the surface of the toner core particle.

A more specific method will be described. First, in a mixing apparatus, hydrochloric acid is added to ion exchange water to prepare an aqueous solvent that is weakly acidic (for example, with a pH value selected from the range of three or more but five or less). Subsequently, to the aqueous solvent with the so adjusted pH value, as a shell material, a dispersion liquid (suspension) of resin fine particles is added along with toner core particles.

Subsequently, while the mixture liquid containing the shell material and the toner core particles is stirred, the temperature of the mixture liquid is raised up to a predetermined holding temperature (e.g., a temperature selected from the range of 50° C. or more but 90° C. or less) at a predetermined rate (e.g., a rate selected from the range of 0.1° C./min or more but 3° C./min or less). Then, while the mixture liquid is stirred, its temperature is held at the holding temperature for a predetermined time (e.g., a length of time selected from the range of 30 minutes or more but 4 hours or less). It is considered that, while the temperature of the mixture liquid is held high, a reaction (fixation of the shell layer) proceeds between the toner core particle and the shell material. The shell material binds to the toner core particle to form the shell layer. The formation of the shell layer on the surface of the toner core particle in the mixture liquid yields a dispersion liquid of toner base particles.

As described above, attaching hydrophobic resin fine particles to the surface of the toner core particle in the mixture liquid and heating the mixture liquid permits the resin fine particles to melt to achieve film formation. Instead, the film formation of the resin fine particles can be promoted by heating them in a drying process, or by subjecting them to physical impact in an external addition process.

After the shell layer is formed as described above, the dispersion liquid of toner base particles is neutralized using, for example, sodium hydroxide. Subsequently, the dispersion liquid of toner base particles is cooled down to, for example, normal temperature (about 25° C.). Then, for example using a Buffner funnel, the dispersion liquid of toner base particles is filtered. This separates the toner base particles from the liquid (solid-liquid separation) to yield the toner base particles in the form of wet cake. Subsequently, the obtained toner base particles in the form of wet cake is washed. Then, the washed toner base particles are dried. After that, as necessary, using a mixer (e.g., an FM mixer produced by Nippon Coke & Engineering. Co., Ltd.), the toner base particles and the external additive can be mixed so that the external additive attaches to the surface of the toner base particles. Incidentally, in a case where a spray dryer is used in the drying process, by spraying a dispersion liquid of the external additive (e.g., silica particles) onto the toner base particles, it is possible to simultaneously perform the drying process and the external addition process.

The processes involved in the above-described production method for toner and their order can be modified freely to suit the desired configuration, properties, or the like of the toner. After the external addition process, the toner can be sieved. Any unnecessary process can be omitted. For example, in a case where a commercially available product can as it is be used as a material, using the commercially available product helps omit the process to prepare that material. In a case where, with no adjustment of the pH value of the mixture liquid, the reaction for forming the shell layer proceeds satisfactorily, the pH value adjustment process can be omitted. In a case where no external additive is attached to the surface of the toner base particles (in a case where the external addition process is omitted), the toner base particle corresponds to the toner particle. For efficient production of toner, it is preferable to produce a large number of toner particles simultaneously. Simultaneously produced toner particles are considered to have substantially an identical configuration.

### (Method for External Addition Treatment)

The method for treatment of the toner base particle with the external additive is not particularly limited; the toner base particle can be treated by any known method. Specifically, the toner base particle is treated with the external additive using a mixer such as a Henschel mixer or a Nauta mixer under treatment conditions adjusted such that particles of the external additive do not sink into the toner base particle.

The toner according to the present disclosure described above excels in fixing properties and heat-resistant preservation properties. In cases where images are formed for a long period in various environments including a high-temperature high-humidity environment and a low-temperature low-humidity environment, the toner can be charged with the desired amount of charge. Thus, images can be formed with the desired density. Accordingly, the toner according to the present disclosure for development of electrostatic latent images can be used suitably in a variety of image forming apparatuses. Now, the effects of the present disclosure will be described more specifically by way of examples. The present disclosure is not limited in any way by those examples.

### EXAMPLES

### Production Example 1

### (Production of Amorphous Polyester Resin)

A four-neck flask with a volume of 5 liters provided with a stirrer (SM-104, produced by AS ONE Corporation), a nitrogen introduction tube, a thermocouple, a dehydration pipe, and a fractionating column was used as a reaction vessel. The reaction vessel was loaded with 1200 g of 1,2-propanediol (petrochemical product) as an alcohol component, 1700 g of terephthalic acid as a carboxylic acid component, and 300 g of trimellitic anhydride. In a nitrogen environment, at 220° C., under an atmospheric pressure, while water was removed, the mixture was reacted for 15 hours. After that, the pressure inside the reaction vessel was reduced down to 8.3 kPa and the reaction was continued for one hour. Subsequently, the temperature inside the reaction vessel was lowered down to 180° C. and 200 g of trimellitic anhydride was added to the reaction vessel. After that, at a rate of 10° C./hour, the temperature inside the reaction vessel was raised up to 210° C. Subsequently, under the atmospheric pressure, at that temperature, the reaction was continued for 10 hours. Then the pressure inside the reaction vessel was reduced down to 20 kPa and the reaction was continued for one hour. When the reaction was complete, the contents of the reaction vessel were taken out and were cooled to obtain amorphous polyester resin A. The softening point Tm of amorphous polyester resin A was 120° C. and its glass transition point Tg was 53° C.

Except that 1,2-propanediol derived from biomass was used, through a procedure similar to that for amorphous polyester resin A, amorphous polyester resin B was obtained.

Except that bisphenol A was used instead of 1,2-propanediol, through a procedure similar to that for amorphous polyester resin A, amorphous polyester resin C was obtained. The source materials and properties of amorphous polyester resins A to C are shown in Table 1.

TABLE 1

| Amorphous Polyester Resin | | A | B | C |
|---|---|---|---|---|
| Components | 1,2-Propanediol (Petroleum) | 1200 | — | — |
| [g] | 1,2-Propanediol (Biomass) | — | 1200 | — |
| | Bisphenol A | — | — | 1200 |
| | Terephthalic Acid | 1700 | 1700 | 1700 |
| | Trimellitic Anhydride | 300 | 300 | 300 |
| Properties | Softening Point [° C.] | 120 | 119 | 114 |
| | Glass Transition Point [° C.] | 53 | 54 | 62 |

### Production Example 2

### (Production of Toner Core Particles)

Using a mixer (FM mixer, produced by Nippon Coke & Engineering. Co., Ltd.), the following were mixed for four minutes at a rotation rate of 2000 rpm to obtain a mixture: as a binder resin, 100 mass parts of one of amorphous polyester resins A to C obtained in Production Example 1; 5 mass parts of a release agent (WEP-9, produced by NOF Corporation); and 6 mass parts of a colorant (MA-100, produced by Mitsubishi Chemical Corporation). Subsequently, using a biaxial extruder (PCM-30, manufactured by Ikegai Co., Ltd.), the mixture was melt-kneaded under the conditions of a spindle rotation rate of 150 rpm, a set temperature range (cylinder temperature) of 100° C., and a processing speed of 100 g/minute to obtain a kneaded product. The kneaded product was cooled, was then coarsely pulverized using a pulverizer (Roteplex, produced by Hosokawa Micron Corporation), and was then finely pulverized using a mechanical pulverizer (Turbomill Model RS, produced by Freund-Turbo Corporation) to obtain a finely pulverized product. Using a classifier (Elbow-Jet Model EJ-LABO, produced by Nittetsu Mining Co., Ltd.), the finely pulverized product was classified to obtain toner core particles C-1 to C-3. The volume average particle size (D50) of the toner core particles was 6.792 μm. The volume average particle size of the toner core particles was measured using a Coulter Counter Multisizer 3 (produced by Beckman Coulter, Inc.).

### Production Example 3

### (Production of a Resin Particle Dispersion Liquid for Forming the Shell Layer)

A three-neck flask with a volume of 1 L provided with a stirrer, a thermometer, a cooling pipe, and a nitrogen introduction pipe was set in a water bath to be used as a reaction vessel. The flask was loaded with 875 mL of ion exchange water at 30° C. and 75 mL of an anionic surfactant (LATEMUL WX, produced by Kao Corporation; component: sodium polyoxyethylene alkyl ether sulfate; solid content concentration: 26 mass %). After that, using the water bath, the temperature inside the flask was raised to 80° C. and was then kept at that temperature (80° C.). Subsequently, to the contents of the flask at 80° C., a mixture liquid obtained by mixing together styrene, 2-hydoxyethyl methacrylate (HEMA) as an alcoholic hydroxy group containing monomer, and butyl acrylate in amounts shown in Table 2 and a solution obtained by dissolving 0.5 g of potassium persulfate in 30 mL of ion exchange water were dropped each over five hours. Then the temperature inside the flask was kept at 80° C. for another two hours to polymerize the contents of the flask. In this way, resin particle dispersion liquids SA1 to SA3 were obtained.

The proportion [wt %] of the alcoholic hydroxy group containing monomer (HEMA) in the shell layer shown in Table 2 was checked by NMR measurement. Specifically, a 1H-NMR spectrometer (JNM-ECX-400, produced by JEOL Resonance Co., Ltd.) was used and, as a solvent, deuterated chloroform was used. The alcoholic hydroxy group containing monomer content was measured and checked based on the peak of the proton of the hydroxy group.

TABLE 2

| | |
|---|---|
| Resin | HEMA |

| Particle | | Added | | Butyl |
|---|---|---|---|---|
| Dispersion | Styrene | Amount | Proportion | Acrylate |
| Liquid | [mL] | [mL] | [mass %] | [mL] |
| SA-1 | 17 | 1.0 | 4.8 | 2.0 |
| SA-2 | 18 | 0.1 | 0.4 | 2.0 |
| SA-3 | 17 | — | — | 3.0 |

### Production Example 4

### [Production of Toners T1 to T5]

### (Shell Layer Formation Process)

A three-neck flask with a volume of 1 L provided with a stirrer, a thermometer, a cooling pipe, and a nitrogen introduction pipe was set in a water bath to be used as a reaction vessel. The flask was loaded with 300 mL of ion exchange water. After that, using the water bath, the temperature inside the flask was kept at 30° C. Subsequently, diluted hydrochloric acid was added into the flask to adjust the pH value of the liquid in the flask to four. Subsequently, the flask was additionally loaded with 150 mL of one of resin particle dispersion liquids SA1 to SA3 obtained in Production Example 3 to obtain aqueous solutions a to c of the source materials of the shell layer.

Subsequently, the flask was additionally loaded with 300 g of one of toner core particles C-1 to C-3 obtained in Production Example 2 and the contents of the flask were stirred for one hour at a rotation rate of 200 rpm. After that, the flask was additionally loaded with 300 mL of ion exchange water. Subsequently, while the mixture in the flask was stirred at a rotation rate of 100 rpm, the temperature inside the flask was raised up to 70° C. at a rate of 1° C./min. Subsequently, under the conditions of a temperature of 70° C. and a rotation rate of 100 rpm, the mixture was stirred for two hours. Subsequently, sodium hydroxide was added into the flask to adjust the pH value of the contents of the flask to seven. Subsequently, the contents of the flask were cooled down to normal temperature (about 25° C.) to obtain a dispersion liquid containing toner base particles.

### (Washing Process)

The obtained dispersion liquid containing toner base particles was filtered using a Buffner funnel to filter out toner base particles in the form of wet cake. The toner base particles in the form of wet cake were once again dispersed in ion exchange water to wash the toner base particles. This washing with ion exchange water was repeated five times.

### (Drying Process)

The toner base particles in the form of wet cake were dispersed in a 50 mass % aqueous solution of ethanol to prepare a slurry. The obtained slurry was fed to a continuous surface improvement device (Coatmizer, produced by Freund Corporation) to dry the toner base particles in the slurry, thereby to obtain toner base particles. The drying using the Coatmizer was performed under the conditions of a hot air temperature of 45° C. and an air blow rate of 2 m³/minute.

### (External Addition Process)

100 mass parts of the toner base particles obtained in the drying process and 1.0 mass part of silica (REA90, produced by Nippon Aerosil Co., Ltd.) were mixed for five minutes using a 10 L Henschel mixer (produced by Nippon Coke & Engineering Co., Ltd.) to attach an external additive. After that, the mixture was sieved using a 200-mesh sieve (with 75 μm openings) to obtain Toners T-1 to T-5.

(Measuring the Coverage Ratio with the Shell Layer)

2.0 g of a sample (toner) was dispersed in 100 g of an aqueous solution of a nonionic surfactant (Emalgen 120, produced by Kao Corporation; component: polyoxyethylene lauryl ether) with a concentration of 2 mass % to obtain a toner dispersion liquid. Subsequently, the obtained toner dispersion liquid was subjected to ultrasonic treatment using an ultrasonic disperser (Ultrasonic Miniwelder P128, produced by Ultrasonic Engineering Co., Ltd.; output: 100 W, oscillation frequency: 28 kHz) to remove the external additive from the toner base particles. Subsequently, the ultrasonic-treated toner dispersion liquid was suction-filtrated with a qualitative filter (Fiter Paper No. 1, produced by Advantec). After that, re-slurrying by addition of 50 mL of ion exchange water and suction filtration were repeated three times to obtain toner base particles (toner having the external additive removed) of the sample (toner).

In an atmospheric environment at normal temperature (25° C.), the obtained toner base particles (powdery substance) were exposed in the vapor of 2 mL of an aqueous solution of RuO₄ with a concentration of 5 mass % to dye the toner base particles with Ru (ruthenium). The dyed toner base particles were photographed using a field-emission scanning electron microscope (FE-SEM) (JSM-7600F, produced by JEOL Ltd.) to obtain an reflection electron image of the toner base particles. Of the surface region of the toner base particle, the part dyed with Ru (dyed region) appeared lighter than the region not dyed with Ru (undyed region). The photographing with the FE-SEM was performed under the conditions of an acceleration voltage of 10.0 kV, an irradiation current of 95 pA, a WD (working distance) of 7.8 mm, a magnification of 5000 times, a contrast of 4800, and a brightness of 550.

Subsequently, using image analysis software (WinROOF, produced by Mitani Corporation), the reflection electron image was subjected to image analysis. Specifically, the reflection electron image was converted into image data in the jpg format, which was then subjected to 3×3 Gaussian filtering. Subsequently, a brightness value histogram (with frequency (number of pixels) along the vertical axis and brightness value along the horizontal axis) of the filtered image data was created. The brightness value histogram showed the distribution of brightness values across the surface region (dyed and undyed regions) of toner base particles. With respect to the brightness value histogram, fitting to a normal distribution by a least square method and waveform separation were performed to obtain an undyed waveform indicating the distribution (normal distribution) of brightness values in the undyed region and a dyed waveform indicating the distribution (normal distribution) of brightness values in the dyed region. Subsequently, from the areas of the two waveforms obtained (i.e., the area RC of the undyed waveform and the area RS of the dyed waveform), Ru (dyed rate, in percent) was calculated according to the expression below and the calculated Ru (dyed rate) was taken as the shell coverage ratio.

$$Ru [ \% ] = 100 \times RS / ( RC + RS )$$

### (Measuring the ¹⁴C Concentration in Toner)

With toner T-2, which used toner core particles C-2 made from 1,2-propanediol derived from biomass as a source material, the concentration of the radioactive carbon isotope ¹⁴C was measured using an accelerator mass spectrometer (AMS). In the presence of CuO, toner T-2 was heated for 0.5 hours at 500° C., was then heated for two hours at 850° C., and meanwhile the carbon dioxide gas produced was collected. With the collected carbon dioxide gas, using the accelerator mass spectrometer, the presence ratio of ¹⁴C to ¹³C to ¹²C was measured. From the amounts of those carbon isotopes measured, the concentration of radioactive carbon isotope ¹⁴C was calculated. For each of toners T-1 to T-5, the type of toner core particles and the type of resin particle dispersion liquid for shell layer formation are listed in Table 3 along with the coverage ratio of the shell layer and the ¹⁴C concentration.

TABLE 3

| | | Shell Layer | | |
|---|---|---|---|---|
| | Toner | Forming Resin | Coverage | ¹⁴C |
| | Core | Particle | Ratio | Concentration |
| Toner | Particle | Dispersion Liquid | [%] | [%] |
| T-1 | A | SA-1 | 79.2 | — |
| T-2 | B | SA-1 | 78.4 | 33.2 |
| T-3 | A | SA-2 | 76.1 | — |
| T-4 | A | SA-3 | 69.3 | — |
| T-5 | C | SA-1 | 68.6 | — |

### (Evaluation of the Heat-Resistant Preservation Properties, Fixing Properties, and Charging Stability of Toner)

For each of the toners of Practical Examples 1 and 2 (T-1 and T-2) according to the present disclosure and the toners (T-3 to T-5) of Comparative Examples 1 to 3, its heat-resistant preservation properties, fixing properties, and charging stability were evaluated by the methods described below.

### (Heat-Resistant Preservation Properties)

10 g of toner (T-1 to T-5) was weighed into a glass bottle and was left to stand still for 100 hours in a constant-temperature chamber set to 50° C. After that, the 10 g of the toner stored in the constant-temperature chamber was put on a 140-mesh sieve (with 106 μm openings) and was sieved with the sieve vibrated for 30 seconds under the condition of a vibration level of 2m/m using a powder tester (produced by Hosokawa Micron Corporation). After the sieving, the mass T (g) of the toner that remained on the sieve was weighed and the remnant toner ratio (the degree of agglomeration of toner) was calculated according to the expression below to be taken as an index of heat-resistant preservation properties.

$$Remnant Toner Ratio [ \% ] = ( T / 10 ) \times 100$$

Seeing that, the higher the remnant toner ratio, the poorer the heat-resistant preservation properties, the heat-resistant preservation properties were evaluated according to the following evaluation criteria:
Good: The ratio of the remnant toner on the mesh was 10% or less.
Poor: The ratio of the remnant toner on the mesh was more than 10%.

### (Low-Temperature Fixing Properties)

First, carrier for developer (carrier for “FSC5250DN” produced by Kyocera Document Solutions) and toner (T-1 to T-5) were weighed such that the ratio (T/C) of toner to carrier was 10 mass % and were sealed in a resin bottle. Next, using a ball mill, the contents of the resin bottle were mixed for 30 minutes at a rotation rate of 100 rpm to obtain evaluation developer (two-component developer). Used as the evaluation machine was a color printer (FS-5200DN, produced by Kyocera Document Solutions) that was modified by removing the fixing device. The evaluation developer was loaded in a developing unit for black in the evaluation machine and a sample (replenishment toner) was loaded in the toner container for black in the evaluation machine.

Using the evaluation machine described above, in a normal-temperature normal-humidity environment (23° C., 50% RH), a solid image (evenly dense image) of a size 25 mm by 25 mm was formed on a recording medium with a basis weight of 90 g/m² (CC90, produced by Mondi) under the conditions of a linear velocity of 200 mm/second and a deposited toner amount of 1.0 mg/cm². Subsequently, the formed unfixed image was fixed to the recording medium under the condition of a linear velocity of 105 mm/second. Used as the evaluation fixing device was a fixing device for a printer (FS-5200DN, produced by Kyocera Document Solutions) modified to be capable of adjusting the fixing temperature and operating independently.

The recording medium after fixing was folded with the image side in and the image on the fold line was rubbed, with a weight of 1 kg wrapped in cloth, back and forth five times. Subsequently, the sheet was unfolded and the folded part (the part where the solid image was formed) of the sheet was inspected. Then, in the folded part, the length (dropout length) over which the toner had come off was measured. According to the length over which the toner had come off, if it was 1 mm or less, the coming-off was evaluated as acceptable and, if it was more than 1 mm, the coming-off was evaluated as unacceptable. The evaluation was done while the fixing temperature was lowered in decrements of 2° C. from 150° C., and the lowest fixing temperature at which the coming-off was evaluated as acceptable was taken as the minimum fixing temperature. The low-temperature fixing properties were evaluated according to the following criteria:
Good: The minimum fixing temperature was 120° C. or less.
Poor: The minimum fixing temperature was more than 120° C.

### (Charging Stability)

Using an electrostatic dissipation tester (NS-D100, produced by Nano Seeds Corporation), the attenuation of the charge amount of toner was measured. This tester is a device that can electrostatically charge a sample and then monitor the attenuation of electric charge with a surface potential meter. The measurement environment was a high-temperature high-humidity environment (32.5° C., 80% RH) and the measured target was a sample that had been left to stand still for 24 hours. The toner (about 50 mg of it) was put on a sample stage, the surface potential meter was set to zero, and then the data was sampled at 10 kV, with a charging time of 0.5 seconds, at a sampling frequency of 10 Hz, and with a maximum measurement time of 300 seconds. The measurement result was substituted in the expression below to calculate a charge attenuation coefficient α at an attenuation time of 2 seconds.

$$V = V 0 exp ( - α √ t )$$

(In the expression, V represents the surface potential [V], V0 represents the initial surface potential [V], and t represents the attenuation time [seconds].) Seeing that, the larger the value of the attenuation coefficient, the more easily the toner loses electric charge and the poorer the charging stability, the charging stability was evaluated according to the following criteria:
Good: The attenuation coefficient was less than 0.0250.
Poor: The attenuation coefficient was 0.0250 or more.

The results of the evaluation of the heat-resistant preservation properties, fixing properties, and charging stability of the toners of Practical Examples 1 and 2 and Comparative Examples 1 to 3 are listed in Table 4.

TABLE 4

| | | Heat-Resistant | | Low-Temperature | | | |
|---|---|---|---|---|---|---|---|
| | | Preservation Properties | | Fixing Properties | | Charging Stability | |
| | | Measured | | Minimum Fixing | | Charge Attenution | |
| | Toner | Value [%] | Evaluation | Temperature [° C.] | Evaluation | Coefficient | Evaluation |
| Practical | T-1 | 6 | Good | 114 | Good | 0.0185 | Good |
| Example 1 | | | | | | | |
| Practical | T-2 | 7 | Good | 116 | Good | 0.0170 | Good |
| Example 2 | | | | | | | |
| Comparative | T-3 | 11 | Poor | 119 | Good | 0.0239 | Good |
| Example 1 | | | | | | | |
| Comparative | T-4 | 13 | Poor | 133 | Poor | 0.0310 | Poor |
| Example 2 | | | | | | | |
| Comparative | T-5 | 16 | Poor | 130 | Poor | 0.0298 | Poor |
| Example 3 | | | | | | | |

As will be understood from Table 4, satisfactory heat-resistant preservation properties, low-temperature fixing properties, and charging stability were obtained with all of toners T-1 and T-2 of Practical Examples 1 and 2 according to the present disclosure, which had toner core particles A and B made from 1,2-propanediol as a source material and a shell layer containing an alcoholic hydroxy group containing monomer and of which the coverage ratio with the shell layer was 75% or more. In particular, in toner T-2 of Practical Example 2, which used toner core particles B made from 1,2-propanediol derived from biomass as a source material, the ¹⁴C concentration in toner was 33.2% and this puts less burden on the environment.

By contrast, while satisfactory low-temperature fixing properties and charging stability were obtained, poor heat-resistant preservation properties resulted with toner T-3 of Comparative Example 1, in which the proportion of the alcoholic hydroxy group containing monomer in the shell layer was 1 mass % or less.

On the other hand, poor heat-resistant preservation properties, low-temperature fixing properties, and charging stability resulted with toner T-4 of Comparative Example 2, in which the shell layer did not contain a repeating unit having an alcoholic hydroxy group, and also with toner T-5 of Comparative Example 3, which used toner core particles C that did not contain 1,2-propanediol.

The above results confirm the following. Forming a toner particle by coating a toner core particle containing a particular polyester resin having a repeating unit derived from 1,2-propanediol with a shell layer containing an alcoholic hydroxy group containing resin, setting the proportion of an alcoholic hydroxy group containing monomer in the alcoholic hydroxy group containing resin forming the shell layer to 1 mass % or more, and setting the coverage ratio with the shell layer to 75% or more contributes to enhancing the chargeability (positives chargeability) of the toner.

The present disclosure finds applications in toner for development of electrostatic latent images for use in an electrophotographic method. Based on the present disclosure it is possible to provide toner for development of electrostatic latent images that excels in heat-resistant preservation properties, low-temperature fixing properties, and charging stability.

What is claimed is:

1. Toner for development of an electrostatic latent image, the toner having a toner particle comprising:
a toner core particle containing, at least, a binder resin and a colorant; and
a shell layer that coats the toner core particle,
wherein
the toner core particle contains as the binder resin a particular polyester resin having a repeating unit derived from 1,2-propanediol,
the shell layer contains an alcoholic hydroxy group containing resin having one or more types of repeating unit having an alcoholic hydroxy group,
a proportion of an alcoholic hydroxy group containing monomer in the alcoholic hydroxy group containing resin is 1 mass % or more, and
a coverage ratio of a surface of the toner core particle with the shell layer is 75% or more.

2. The toner according to claim 1, wherein
the alcoholic hydroxy group containing resin has a repeating unit represented by General Formula (1) below and a repeating unit represented by General Formula (2) below: 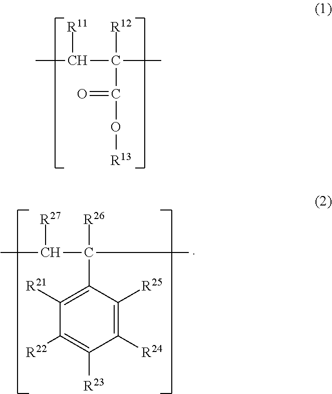
where,
in Formula (1),
R¹¹ and R¹² each independently represent a hydrogen atom, a halogen atom, or an alkyl group that can have a substituent; and
R¹³ represents an alkylene group that has a hydroxy group, and
in Formula (2),
R²¹ and R²⁷ each independently represent a hydrogen atom, a halogen atom, a hydroxy group, an alkyl group that can have a substituent, an alkoxy group that can have a substituent, an alkoxyalkyl group that can have a substituent, or an aryl group that can have a substituent.

3. The toner according to claim 2, wherein
the alcoholic hydroxy group containing monomer is a 2-hydoxyethyl methacrylate.

4. The toner according to claim 1, wherein
the toner core particle is formed from biomass-derived 1,2-propanediol as a source material.

5. The toner according to claim 4, wherein
a concentration of a radioactive carbon isotope ¹⁴C in the toner particle is 26.9 pMC or more.
